(19) United States
(12) Patent Application Publication
(10) Pub. No.: US 2013/0062383 A1
(43) Pub. Date: Mar. 14, 2013

(54) VEHICLE-MOUNTABLE BICYCLE CARRIER WITH SECURING JAW

(71) Applicant: Richard Jeli, Milwaukie, OR (US)

(72) Inventor: Richard Jeli, Milwaukie, OR (US)

(73) Assignee: YAKIMA PRODUCTS, INC., Beaverton, OR (US)

(21) Appl. No.: 13/608,888

(22) Filed: Sep. 10, 2012

Related U.S. Application Data
(60) Provisional application No. 61/533,100, filed on Sep. 9, 2011.

(51) Int. Cl. B60R 9/10

(52) U.S. Cl. 224/497; 224/553; 224/502; 224/324; 224/549

(57) ABSTRACT

A vehicle-mountable bicycle carrier includes a linkage device for mounting the carrier to a vehicle, a base portion or platform to support both wheels of a bicycle, and an arm assembly connected to the base portion. The arm assembly may include a mast member and a jaw member. The jaw member may have a mounting portion received on the mast member and a hook portion attached to the mounting portion and configured to engage a bicycle frame and/or a top portion of a bicycle wheel. The jaw member may have a released configuration where the jaw member, as a unit, is pivotable about and slidable up and down the mast member while the mounting portion remains on the mast member.

### CROSS-REFERENCE TO PRIORITY APPLICATION

This application claims priority under 35 U.S.C. §119(e) to U.S. Provisional Patent Application Ser. No. 61/533,100, filed Sep. 9, 2011, which is incorporated herein by reference in its entirety for all purposes.

### CROSS-REFERENCES TO OTHER MATERIALS

The following patent documents are incorporated herein by reference in their entirety for all purposes: U.S. Pat. No. 7,815,084; U.S. Pat. No. 8,235,267; and U.S. Patent Application Publication No. 2009/0236382.

### BACKGROUND

The popularity of recreational and competitive cycling has grown substantially in recent years, with a corresponding expansion in the number of different bike designs and configurations. As a result, the demand for bicycle carriers to transport bikes of varying dimensions and designs on cars and other vehicles also has grown significantly. There are various types of vehicle-mounted bicycle carriers available. One type is the platform carrier, which provides a platform for supporting the wheels of the bicycle(s). Platform carriers are often mounted on the trailer hitch of a vehicle to carry one or more bicycles adjacent the rear of the vehicle. Typically, platform carriers include securing arms or other components to secure one or more bicycles to the platform. Innovation is still needed to improve platform carrier designs for accommodating bicycles of different configurations in a stable and secure manner while also facilitating loading and removal of the bicycles from the carrier.

### SUMMARY

The present disclosure provides a vehicle-mountable bicycle carrier. An exemplary carrier includes a linkage device for mounting the carrier to a vehicle, a base portion or platform to support both wheels of a bicycle, and an arm assembly connected to the base portion. The arm assembly may include a mast member and a jaw member. The jaw member may have a mounting portion received on the mast member and a hook portion attached to the mounting portion and configured to engage a bicycle frame and/or a top portion of a bicycle wheel. The jaw member may have a released configuration where the jaw member, as a unit, is pivotable about and slidable up and down the mast member while the mounting portion remains on the mast member.

### BRIEF DESCRIPTION OF THE DRAWINGS

FIG. 1 is a view of an exemplary bicycle carrier mounted to a vehicle hitch at the rear of a vehicle, with the carrier being collapsible and having a pair of adjustable jaw members to secure a pair of bicycles.

FIG. 2 is an exploded view of the carrier and vehicle hitch of FIG. 1.

FIG. 3 is a sectional view of an arm of the bicycle carrier of FIG. 2, taken generally along line 3-3 of FIG. 4 through a ratchet mechanism formed collectively by a jaw and a mast of the arm.

FIG. 4 is another sectional view of the arm of FIG. 2, taken generally along line 4-4 of FIG. 2.

FIG. 5 is a fragmentary view of the bicycle carrier of FIG. 2, taken generally at the region indicated at “5” in FIG. 2 with the bicycle carrier in a partially collapsed configuration.

FIG. 6 is another fragmentary view of the bicycle carrier of FIG. 2, taken generally at the region indicated at “6” in FIG. 2 with the arm unlocked to enable the arm to be pivoted away from the vehicle.

FIG. 7 is a view of a modified version of the bicycle carrier of FIG. 1 mounted above a vehicle to crossbars of a vehicle rack.

### DETAILED DESCRIPTION

The present disclosure provides a vehicle-mountable bicycle carrier. An exemplary carrier includes a linkage device for mounting the carrier to a vehicle, a base portion or platform to support both wheels of a bicycle, and an arm assembly connected to the base portion. The arm assembly may include a mast member and a jaw member. The jaw member may have a mounting portion received on the mast member and a hook portion attached to the mounting portion and configured to engage a bicycle frame and/or a top portion of a bicycle wheel, to secure the bicycle to the carrier. The jaw member may have a released configuration where the jaw member, as a unit, is pivotable about and slidable up and down the mast member while the mounting portion remains on the mast member.

In some embodiments, the bicycle carrier may be mounted on a trailer hitch at the rear end of a vehicle. The carrier may include a hitch-mounting portion or tongue portion and a base portion or horizontal bar portion having at least one pair of wheel retaining members or wheels supports adjustably clamped to the base portion and configured to receive the front and rear wheels of a bicycle. Additionally, a vertical mast member may be mounted at the center of the base portion, with one or more bicycle-securing jaw members attached to the mast member. A flat side of the mast member may have a plurality of ratchet teeth. Each jaw member may include a mounting portion mounted coaxially on the mast member and a hook portion attached to, extending from, and/or supported by the mounting portion. The mounting portion may include a handle member or housing connected to an actuator or trigger member that is configured to engage the ratchet teeth on the flat side of the mast member, to form a ratchet mechanism. Additionally, the actuator may be configured such that depression of the actuator disconnects the actuator from the teeth of the mast member and allows the housing to be rotated around the mast member. The hook portion may be fixedly mounted to the housing of the jaw member, such as approximately 90 degrees from the actuator. Rotation of the housing therefore also rotates the hook portion. The hook portion may be used to securely hold the top tube or other suitable portion of a bicycle on the carrier by lowering the hook portion onto the bicycle. The ratchet mechanism may be configured to allow free motion of the hook portion in a downward or securing direction, but to prevent motion in an upward or releasing direction, unless the actuator is depressed. The addition of a second degree of freedom in the form of rotational motion allows the hook portion to be easily relocated out of the way while loading a bicycle onto the carrier and then moved back into operational position after the bicycle is loaded.

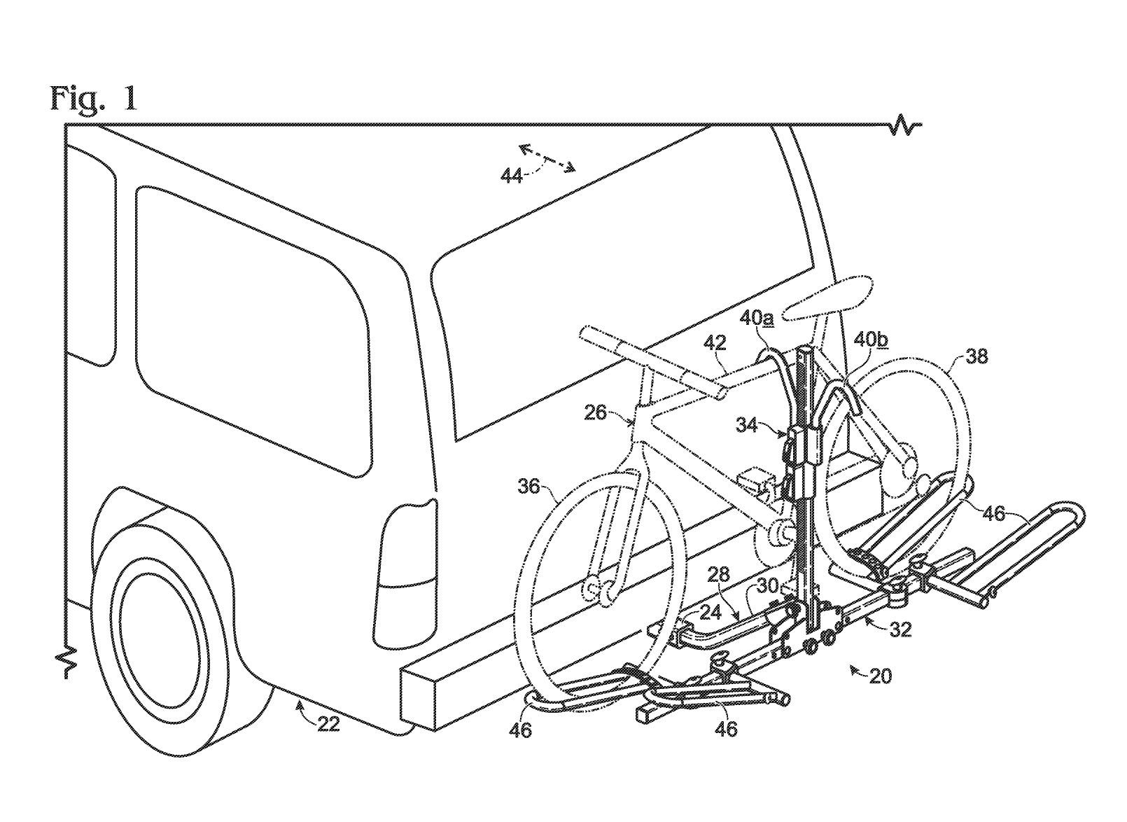

FIG. 1 shows an exemplary bicycle carrier 20 mounted to the rear of a vehicle 22 at a trailer hitch 24 of the vehicle. A bicycle 26 secured to carrier 20 is shown in phantom outline. Carrier 20 includes a linkage device 28, such as a tongue portion 30 (interchangeably termed a tongue), for mounting the carrier to a vehicle. The carrier also includes a base portion 32 (interchangeably termed a base or platform) connected to the linkage device, and an arm assembly 34 (interchangeably termed an arm) connected to the base. The bicycle is supported by base 32 and is clamped between base 32, which contacts front and rear wheels 36, 38 of bicycle 26, and a hook portion 40a (or 40b) (interchangeably termed a hook) provided by arm 34.

The hook may secure the bicycle to the carrier by engaging the bicycle's frame and/or a top portion of a wheel of the bicycle. Since frame geometries vary widely for bicycles, a suitable site for securing a given bicycle with the hook may be determined based on the frame design of that particular bicycle. In some cases, the hook may engage an upper region of the bicycle, above the bicycle's center of mass, to secure the bicycle more effectively. In any event, the hook may engage any suitable region of the bicycle's frame, such as a top tube 42, seat tube, down tube, or seat stay, among others. The frame region engaged may be at least generally horizontal. Alternatively, or in addition, the hook may engage a top portion of a bicycle wheel, as disclosed in U.S. Pat. No. 7,815,084, and U.S. Patent Application Publication No. 2009/0236382, which are incorporated herein by reference.

Linkage device 28 mounts carrier 20 to vehicle 22. Linkage device 28 may attach the carrier to any suitable vehicle and at any suitable position relative to the vehicle. For example, the linkage device may attach the carrier to the rear of a vehicle (e.g., a hitch-equipped vehicle, such as a sport utility vehicle, van, or truck), to the front of a vehicle (e.g., a bus), to the top of a vehicle (e.g., a car equipped with crossbars), to the bed of a truck, or the like. Accordingly, the carrier may be mounted in front of, behind, above, or in the vehicle.

Carrier 20 may be configured to receive and secure any suitable number of bicycles. For example, the carrier may be configured to carry at least one bicycle, a pair of bicycles (e.g., disposed on opposing sides of arm 34), or three or more bicycles (e.g., if the carrier has more than one arm 34 connected to base 32). The bicycles may be carried side by side, with their frames parallel to one another. Each bicycle may be arranged with its frame orthogonal (as in FIG. 1) or parallel (see below) to a long axis 44 (or travel axis) of the vehicle.

Base 32 is configured to receive and support both wheels of a bicycle and includes at least one wheel support or wheel retainer 46 to perform these functions. In the depicted embodiment, the carrier has a distinct wheel support 46 for each bicycle wheel (i.e., two supports 46 per bicycle). In other examples, the same wheel support (e.g., a tray) may be used to receive and engage both wheels of a bicycle.

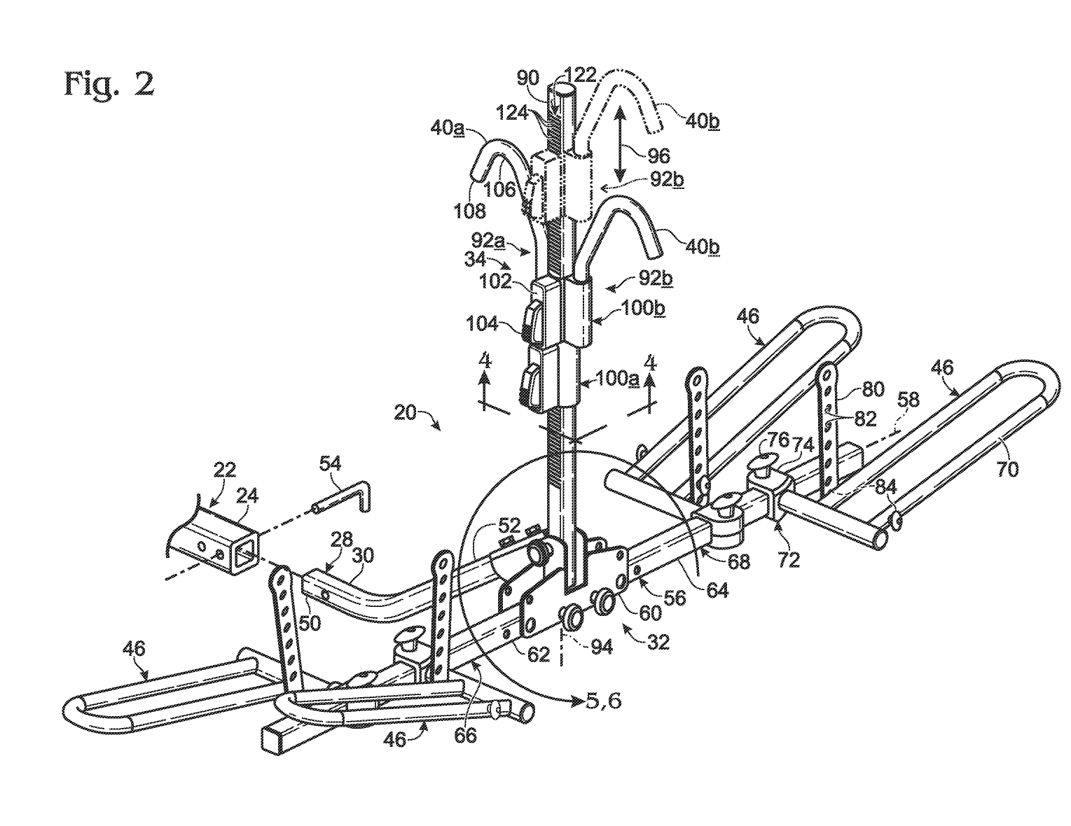

FIG. 2 shows a magnified view of carrier 20. Tongue 30 has a proximal end portion 50 configured to be connected to vehicle hitch 24 and a distal end portion 52 connected to base 32 (e.g., fixed to the base). The proximal end of tongue 30 may be sized to be received by the vehicle hitch and may include an aperture that aligns with an aperture of the hitch when the tongue is mated with the hitch. In the depicted embodiment, a fastener (e.g., an L-shaped pin 54 or a bolt) is placed in the aligned apertures to secure tongue 30 to hitch 24. The tongue may be configured such that distal end portion 52 is elevated with respect to proximal end portion 50 when the tongue is attached to hitch 24, to elevate base 32 higher above the ground. For example, tongue 30 may have a bent configuration as shown.

Base 32 includes a frame portion 56 to which wheel supports 46 are mounted. The frame portion may extend parallel to a long axis 58 defined by the base. The frame portion may be composed of a central region or hub region 60 (e.g., a bracket assembly) and a pair of frame members or bar members 62, 64 connected to the central region and extending parallel to long axis 58 in opposite directions from the central region. Base 32 and/or frame portion 56 may be foldable to a collapsed configuration, to reduce the length thereof. For example, frame members 62, 64 may be pivotably connected to central region 60, as described in more detail below. In some embodiments, the frame portion may have a horizontal bar or bar assembly forming a spine and defining a long axis of the frame portion. In some embodiments, the frame portion may have at least a pair of longitudinal frame members arranged side-by-side and/or one or more transverse frame members extending horizontally and orthogonally to the longitudinal frame members. Other exemplary configurations for the base, and particularly the frame portion thereof, are described in the patent documents listed above under Cross-References, which are incorporated herein by reference, particularly U.S. Pat. No. 7,815,084; U.S. Pat. No. 8,235,267; and U.S. Patent Application Publication No. 2009/0236382.

Base 32 may have end regions 66, 68 extending in respective opposite directions from central region 60. Each end region 66, 68 may include at least one wheel support 46 or at least a pair of wheel supports. Each end region 66, 68 may be pivotably connected to central region 60, such as via frame member 62 or 64.

Each wheel support 46 is configured to receive and engage at least one bicycle wheel. The wheel support may define an opening, such as a recess or through-hole, to receive the wheel. If a pair of wheel supports are utilized to support both wheels of a bicycle, the openings defined by the pair of wheel supports may be about the same size or may be different in size. Each wheel support may be configured to contact the tire of a bicycle wheel at one or more positions, such as at a pair of circumferentially spaced positions on the outer perimeter of the tire.

In the depicted embodiment, each wheel support 46 includes a hoop member 70 and a coupling member 72 that attaches the hoop member to frame portion 56 (e.g., to bar member 62 or 64). The hoop member or other wheel support 46 may or may not be adjustably positionable along the frame portion. For example, the wheel support may be slidable along and then fixable with respect to frame portion 56. In the depicted embodiment, coupling member 72 includes a clamp 74 that can be adjusted via a user control, such as a knob 76. The clamp can be loosened, to permit the wheel support to slide along the frame portion, and tightened, to fix the longitudinal position of the wheel support along the frame portion/bar member. Each wheel support 46 may or may not be positionable independently along frame portion 56. For example, coupling members 72 each may occupy a different position along the frame portion, as shown here. In this case, the coupling members may be arranged in an alternating configuration, where the hoop members or other wheel supports 46 alternate between opposing sides of the frame portion, to permit the two pairs of wheel supports 46 on opposing sides of arm 34 to be spaced equally relative to each other (e.g., to receive the same size of bicycle on each side of the arm) or to be adjusted to receive a pair of bicycles having different wheel spans. In some cases, a pair of wheel supports 46 may be attached to the same coupling member 72. In other embodiments, hoop member 70 may be replaced by a well or a tray.

Hoop member 70 (or other wheel support 46) may be horizontal or may be inclined with respect to horizontal, such as extending at an angle of about 5-60, 10-50, or 15-45 degrees with respect to horizontal. The hoop member may be angled upward, as shown here, such that the distal end of the hoop member (i.e., distal to coupling member 72) is higher than the proximal end of the hoop member and/or higher than the adjacent bar member 62 or 64. In other cases, the hoop member (or other wheel support) may be angled downward.

Each wheel support 46 may include or be operatively connected to a strap member 80 (interchangeably termed a strap or securing member). Strap 80 can be manipulated to secure a bicycle wheel to the wheel support. The strap may be configured to extend through the supported wheel (e.g., between spokes), to engage the wheel's rim when the strap is tensioned (see FIG. 1). The strap may be configured to be secured to wheel support 46 on opposing sides of the bicycle wheel. In the depicted embodiment, strap 80 is elastic and has a line of perforations 82 each sized to be stretched as the perforation is placed over a protrusion 84 formed on each opposing side of hoop member 70. The tension on the strap member can be selected based on which perforations are received over the protrusions. In other embodiments, the strap may be secured by a buckle, which may cooperate with the strap to form a ratchet mechanism.

Arm 34, in a use position, extends upwardly (e.g., substantially vertically) from base 32. The arm may include a mast member 90 (interchangeably termed a mast) and at least one retainer or jaw member 92a, 92b (interchangeably termed a jaw) slidably mounted on and supported by the mast. Mast 90 may be connected to base 32 via a proximal end of the mast, with the mast extending upwardly (e.g., substantially vertically) from the base to a distal end that is spaced from the base. Each jaw 92a, 92b is slidable upward and downward along the mast, parallel to a long axis 94 of mast 90, as indicated by a motion arrow 96 and by jaw 92b repositioned in phantom outline after sliding the jaw upward to a higher position on the mast.

Each jaw 92a, 92b provides a hook portion 40a, 40b for engaging a bicycle and also provides a mounting portion 100a, 100b that mounts the jaw (and hook portion) to mast 90. Each mounting portion may include a body or housing 102 (interchangeably termed a handle member) and an actuator or release member 104 connected to body 102.

Hook portions 40a, 40b each may extend from, and may be fixed with respect to, the corresponding body 102 of each mounting portion 100a, 100b. As a result, each respective jaw 92a, 92b may slide and pivot as a unit with respect to mast 90 (and independently of the other jaw). At least most of the hook portion of each jaw may be disposed above the attached mounting portion. The hook portion may extend upwardly from its associated mounting portion and then bend downward at a crest region 106 of the hook portion to form a tip region 108 disposed below the crest region and pointing downward. The hook portion may engage the frame or wheel of a bicycle at crest region 106.

In the depicted embodiment, arm 34 includes a pair of jaws 92a, 92b. The jaws may have their respective mounting portions 100a, 100b arranged with one above the other on mast 90. Jaws 92a, 92b may be movable independently of one another along and/or about mast 90. Hooks portions 40a, 40b may be of different length (and/or may extend different distances above their respective mounting portions), to compensate for the nonoverlapping vertical positions of the respective mounting portions. For example, in the depicted embodiment, hook portion 40a of jaw 92a is attached to lower mounting portion 100a and has a longer shaft than hook portion 40b, which is attached to upper mounting portion 100b. The difference in length of the hook portions and/or shafts thereof may be about, or at least about, the height of a mounting portion, as measured parallel to the long axis of mast 90. This design of hook portions allows crest regions 106 of both hook portions, if desired or needed, to be placed at the same elevation as each other, for a majority of the linear travel range of each jaw, to hold two bicycles of the same size. This arrangement also may allow two bicycles to be secured to the carrier even if the two bicycles have different heights or are secured at points differing in height.

In other embodiments, the carrier may have a different arrangement of one or more masts and two or more jaws. For example, mast 90 may support three or more jaws, such as a pair of jaws for each bicycle to be secured. In this case, a pair of the jaws may engage a bicycle at different positions along the bicycle (e.g., each jaw engaging an upper portion of a different bicycle wheel or the jaws engaging spaced positions along the top tube of the bicycle's frame, among others). As another example, the carrier may have a pair of masts or mast portions arranged laterally to one another, with at least one jaw mounted on each mast or mast portion. In this arrangement, the arm may have a pair of mast portions connected to one another distally to form an inverted-U-shaped mast structure. In other examples, the carrier may have at least two masts each supporting a respective jaw, with the masts connected to each other proximally via the base and not connected to one another distally.

FIG. 3 shows a sectional view taken longitudinally through mast 90 and mounting portion 100a. Mast 90 forms a ratchet mechanism 120 collectively with mounting portion 100a (and another ratchet mechanism collectively with mounting portion 100b). The mast provides a rack 122 (a toothed bar) having a set of teeth 124 arranged linearly along the mast (see FIG. 2 also). The same set of teeth 124 may be used for both ratchet mechanisms, or a distinct set of teeth may be used for each ratchet mechanism, such as with each set of teeth 124 formed on a different side of the mast for each mounting portion. The teeth may be uniform in shape and may be spaced uniformly along the mast. The teeth may be symmetrical in profile, as shown here, or may be asymmetrical to facilitate travel of each mounting portion in only one direction along the mast when ratchet mechanism 120 is engaged.

Each mounting portion 100a, 100b provides a pawl member 126 (interchangeably termed a pawl) that cooperates with teeth 124 of mast 90 to form ratchet mechanism 120. Pawl 126 may have one or more teeth 128 that engage one or more teeth 124 of the mast, to limit movement of the mounting portion and its corresponding hook portion. Pawl 126 may be pivotably mounted to body 102 of the mounting portion, such as via a pivot pin 130 disposed at a lower elevation than the toothed end of the pawl. The pawl may be spring-biased by a spring 132, which urges pawl 126 toward mast 90, into engagement with teeth 124 of the mast. Pawl 126 may be provided by actuator 104 or may be operatively connected to the actuator, among others.

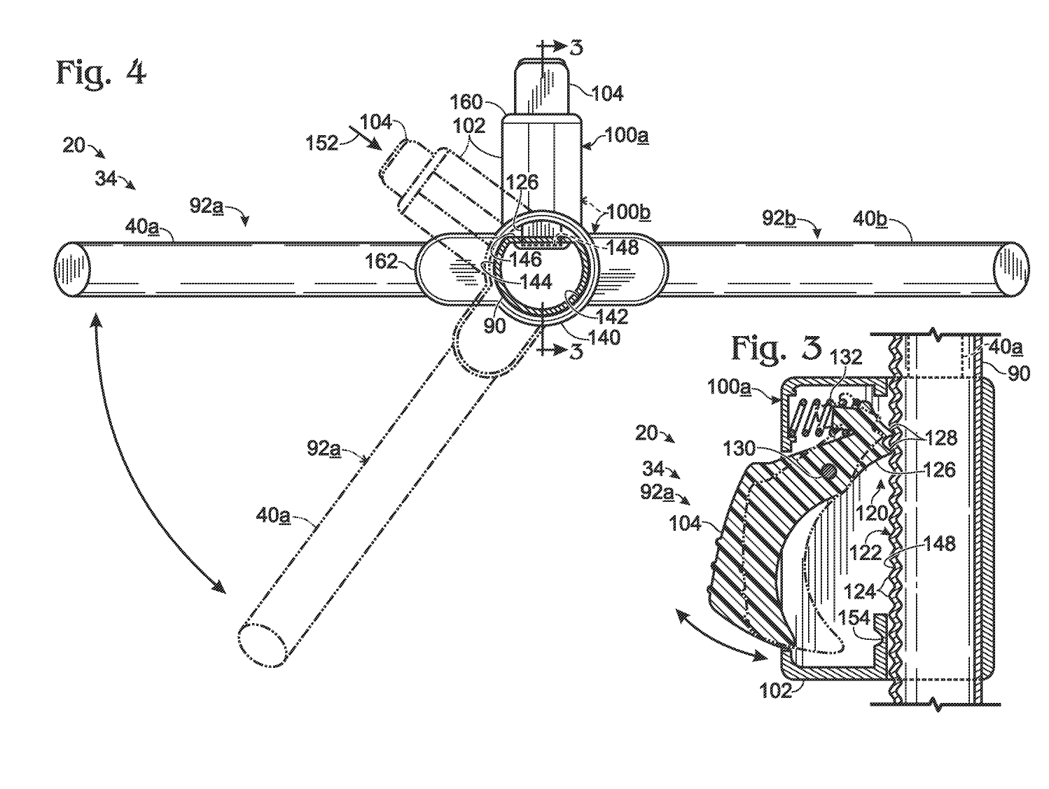

FIG. 4 shows a sectional view of arm 34. Mast 90 extends through both mounting portions 100a, 100b. For example, each mounting portion may provide a sleeve member 140 that extends around the mast. The sleeve member may define an opening 142 sized to receive a partially cylindrical mast, to permit rotation of each mounting portion about the mast. Opening 142 may have a radius that corresponds to the radius of the mast, particularly a cylindrical region thereof. Each mounting portion (and jaw member) may be physically limited, for example, to approximately 90 or 180 degrees of rotation around the mast member, or rotation may be unlimited to allow 360 degrees of rotation when the mounting portion is disposed in its released configuration.

Mast 90 may include a cylindrical region 144 and a generally flat side or flat face 146 arranged about the mast from each other (see FIGS. 2 and 4). In some cases, the mast may be roughly D-shaped in cross section, and may be described as a tube that has at least one generally flat side. Flat side 146 may provide teeth 124 (also see FIG. 3). The teeth may created by recesses 148 (e.g., grooves) formed in the flat side, as projections (e.g., ridges) formed on the flat side, or a combination thereof. In some cases, recesses 148 may be preferred because lateral wall regions formed at the ends of each recess can act as a rotational stop to further ensure that the jaw does not pivot until the pawl/actuator is retracted.

In the engaged or securing configuration of FIGS. 3 and 4, mounting portion 100a (or 100b) can slide down mast 90, with pawl 126 (and/or actuator 104) pivoting slightly away from the mast as it rides over each ramped tooth surface, to travel past each successive tooth on mast 90. However, sliding of mounting portion 100a (or 100b) up the mast is prevented in the engaged configuration of ratchet mechanism 120 because an upward force on mounting portion 100a (or 100b) urges pawl 126 (and/or actuator 104) toward the mast, instead of away from the mast when the mounting portion is urged downward, which only forces the pawl more tightly against the mast. Pivotal motion of the mounting portion about the mast also may be prevented by engagement of pawl 126 with teeth 124.

FIGS. 3 and 4 illustrate manipulation of actuator 104, in phantom outline, to release mounting portion 100a (and its corresponding jaw 92a) by placing ratchet mechanism 120 in a disengaged or released configuration. Manipulation of actuator 104, such as by pressing the actuator, indicated by an arrow at 152 in FIG. 4, retracts and disengages the pawl (and actuator 104) from teeth 124 of the mast. As a result, mounting portion 100a can pivot about the mast and can slide both up and down the mast. Jaw 92a in a pivoted orientation is shown in phantom outline in FIG. 4, with actuator 104 of the jaw in a depressed position closer to the mast. A stop 154 formed by body 102 of mounting portion 100a may limit travel of actuator 104 to define a fully pressed-in or depressed position that reliably releases the mounting portion (see FIG. 3). In some cases, actuator 104 also or alternatively may be described as a release member or a trigger member.

Ratchet mechanism 120 may be placed in the disengaged/released configuration before a bicycle is secured, to allow pivoting of the hook portion to a receiving position parallel to the long axis of the base and to permit the hook portion to be raised such that the tip region of the hook portion is above the bicycle and/or the region of the bicycle to be engaged. Once pivoted out of alignment with the teeth of the mast, the jaw may remain in the released configuration without the need to maintain pressure on actuator 104. After the wheels of the bicycle are placed in the wheel supports, the hook portion can be pivoted back to its operative orientation, orthogonal to the long axis of the base. In this position, the ratchet mechanism can re-engage unless the actuator is pressed continuously. With the ratchet mechanism again operative, the hook portion can be urged downward into engagement with the bicycle, to secure the bicycle to the carrier. When the bicycle is to be unloaded from the carrier, actuator 104 again can be pressed, and the hook raised, and optionally pivoted, to permit removal of the bicycle from the wheel supports.

The mounting portion, in addition to sleeve member 140, also may include a control region 160, providing actuator 104, and a hook-supporting region 162 from which hook portion 40a or 40b extends and to which the hook portion may be fixed. The control region and the hook-supporting region each may project from sleeve member 140 of the corresponding jaw and may be aligned or may be offset from each other around the mounting portion, such as offset by about 90 degrees as shown here. Accordingly, hook portion (40a or 40b) of the jaw may be offset by about 90 degrees from the corresponding actuator 104. In other embodiments, regions 160, 162 (and the corresponding hook portion and actuator) may be offset from each other by about 45, 60, 120, or 180 degrees, among others. The control regions of the jaws may be aligned with one another when the ratchet mechanisms are engaged, as shown here, or may be offset from one another about the mast. Also, the respective hook-supporting regions 162 of the jaws may be offset from each other, such as offset by 180 degrees as shown here, such that hook portions 40a, 40b are opposite each other across mast 90.

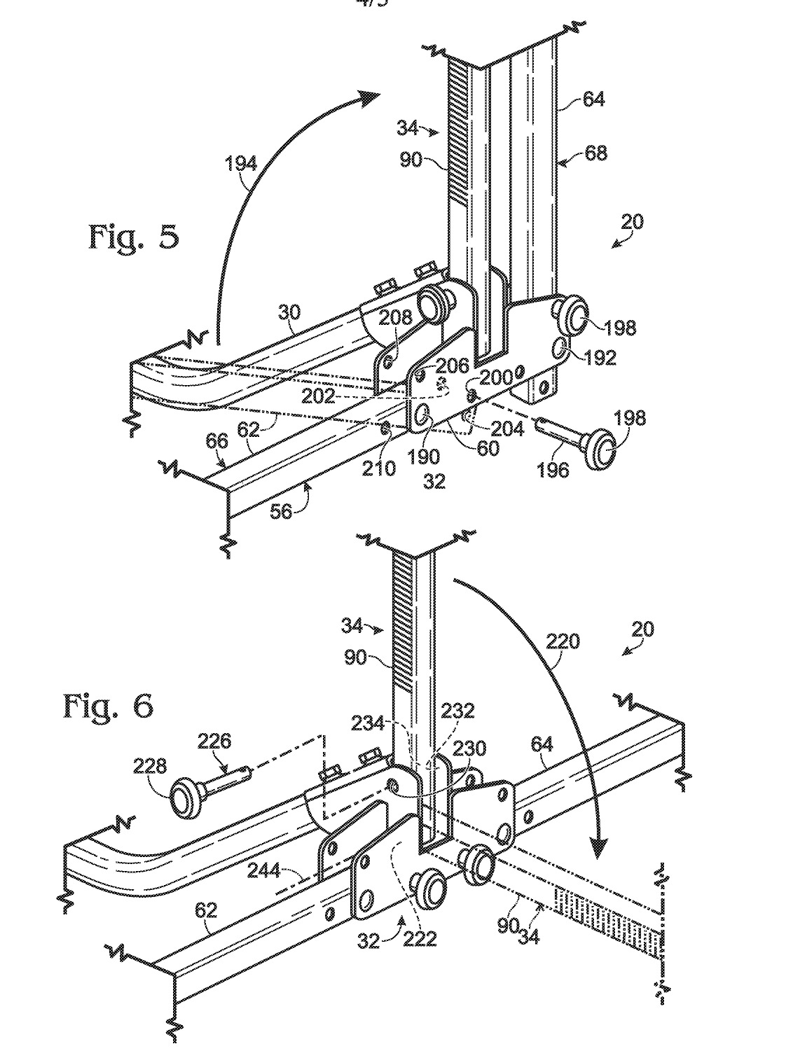

FIG. 5 shows bicycle carrier 20 in a partially collapsed configuration. Frame portion 56 may include a pair of pivotable joints 190, 192 that pivotably connect frame members 62, 64 to hub region 60. Each pivotable joint may define a horizontal pivot axis that is transverse to the long axis of the base (in its use configuration) and transverse to a plane defined by the frame of a bicycle secured to the carrier. Each joint permits the associated frame member (62 or 64) or end region (66 or 68) to pivot, indicated by an arrow at 194, from a horizontal use position (shown for frame member 62/end region 66) to a vertical storage position (shown for frame member 64/end region 68). (A partially pivoted position of frame member 62 is shown in phantom outline.) Each frame member may be locked in each position with a locking member or detent member 196, such as a pin 198 having a graspable head. The locking member may be manipulated to switch each frame member and end region between a locked configuration and an unlocked or pivotable configuration. For example, pin 198 may be received in a first set of two or more coaxially-aligned apertures, such as apertures 200-204, to lock the frame member in a horizontal position and in a second set of two or more coaxially-aligned apertures, such as apertures 206-210, to lock the frame member in a vertical position. The apertures may be formed by hub region 60 (e.g., apertures 200, 202, 206, and 208) and one of the frame members (e.g., apertures 204 and 210). The locking member may be removed from the apertures to place the frame member in a pivotable configuration. In a more fully collapsed configuration, each frame member and/or end region may be arranged vertically, with the frame members (and/or end regions) disposed on respective opposing sides of arm 34 (and/or mast 90), with the frame members parallel to the mast. The collapsed configuration may reduce the length of base 32 by at least about one-half and may position the base vertically.

FIG. 6 shows bicycle carrier 20 with arm 34 unlocked to enable the arm to be pivoted, indicated by an arrow at 220, away from the vehicle. The proximal end of the arm may be connected to hub region 60 at a pivotable joint 222. The joint may define a pivot axis 224 that is horizontal and orthogonal to the long axis of mast 90 (and/or arm 34) and/or parallel to the long axis of the base. Arm 34/mast 90 may be locked in a vertical use portion by a locking member or detent member 226, such as a pin 228 having a graspable head. Pin 228 may be received in a set of two or more coaxially aligned apertures, such as apertures 230-234, formed by hub region 60 and mast 90, to lock the arm in a vertical position. The pin may be removed to permit the arm to pivot to a more horizontal position, indicated in FIG. 6 with the mast in phantom outline.

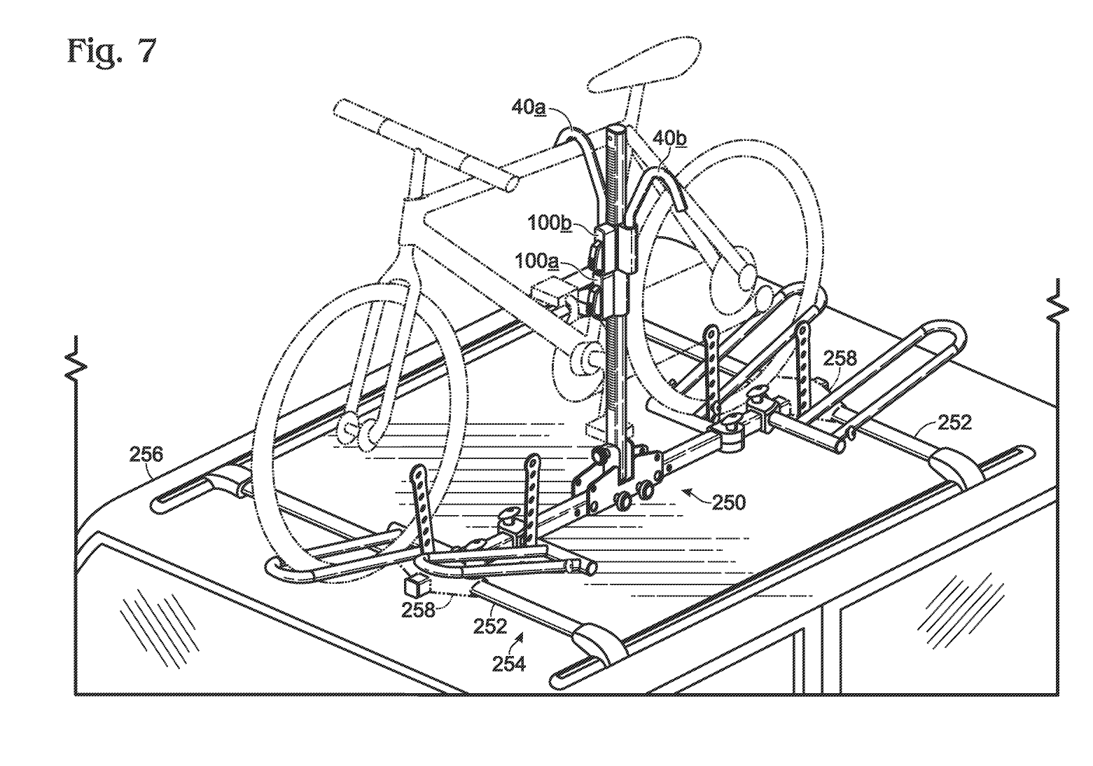

FIG. 7 shows a modified embodiment 250 of bicycle carrier 20 mounted to crossbars 252 of a vehicle rack 254 above a vehicle 256. Here, carrier 250 has a pair of linkage devices 258, such as clamps, that attach the carrier to each crossbar 252. Hook portions 40a, 40b may be longer in carrier 250 (than carrier 20), to position mounting portions 100a, 100b lower on the carrier, for easier access by a user standing on the ground next to the vehicle.

This application also incorporates herein by reference in their entirety for all purposes the following U.S. Pat. Nos. 6,857,545, 6,761,297, 6,523,731, 6,439,397, 6,053,336, 6,019,266, 5,833,074, 5,692,659, 5,169,042, 5,029,740, 4,875,608, 4,823,997, 4,702,401, 4,524,893, 4,437,597, 4,403,716, 4,213,729, 4,171,077, 3,744,689, 1,179,823, 623,807, 614,264, 607,024, 586,681, 576,351, 556,789, 529,827 and 488,395.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure. Further, ordinal indicators, such as first, second, or third, for identified elements are used to distinguish between the elements, and do not indicate a particular position or order of such elements, unless otherwise specifically stated.

I claim:

1. A carrier for a bicycle, comprising:
a linkage device configured to be mounted to a vehicle;
a base portion connected to the linkage device and configured to receive and support both wheels of a bicycle; and
an arm assembly connected to the base portion and including a mast member and a jaw member, the jaw member having a mounting portion received on the mast member and a hook portion attached to the mounting portion and configured to engage a bicycle frame and/or a top portion of a bicycle wheel, the jaw member having (a) a securing configuration where the jaw member is slidable down the mast member and is prevented from pivoting about and sliding up the mast member, and (b) a released configuration where the jaw member, as a unit, is pivotable about and slidable up and down the mast member while the mounting portion remains on the mast member.

2. The carrier of claim 1, wherein the linkage device includes a tongue portion having a proximal end portion and a distal end portion, the proximal end portion being configured for connection to a vehicle hitch and the distal end portion being connected to the base portion.

3. The carrier of claim 1, wherein the linkage device includes a clamp device configured to attach the base portion to a crossbar above a vehicle.

4. The carrier of claim 1, wherein the base portion includes a hoop member configured to receive a bicycle wheel and a strap member that secures such bicycle wheel to the hoop member.

5. The carrier of claim 1, wherein the base portion includes a central region and a pair of end regions projecting in opposite directions from the central region, wherein each end region is configured to receive and support a bicycle wheel, and wherein each end region is pivotable with respect to the central region between a horizontal use position and a vertical storage position.

6. The carrier of claim 5, wherein each end region of the base portion is lockable in the vertical storage position.

7. The carrier of claim 1, wherein the base portion defines a long axis, and wherein the arm assembly has a pivotable configuration that allows the arm assembly to pivot as a unit with respect to the base portion about a pivot axis that is parallel to the long axis.

8. The carrier of claim 1, wherein the mounting portion of the jaw member includes a sleeve member, and wherein the mast member extends through the sleeve member in the securing configuration and the released configuration of the jaw member.

9. The carrier of claim 1, wherein the mounting portion includes an actuator configured to be manipulated by a user to place the jaw member in the released configuration from the securing configuration.

10. The carrier of claim 9, wherein the mast member and the mounting portion collectively form a ratchet mechanism including a set of teeth and a pawl, and wherein pressing the actuator disengages the pawl from the set of teeth to place the jaw member in the released configuration.

11. A carrier for a bicycle, comprising:
a linkage device configured to be mounted to a vehicle;
a base portion connected to the linkage device and configured to receive and support both wheels of a bicycle; and
an arm assembly connected to the base portion and including a mast member and a jaw member supported by the mast member, the jaw member having a mounting portion disposed around the mast member and a hook portion fixedly attached to the mounting portion and configured to engage a bicycle frame and/or a top portion of a bicycle wheel, the mast member and the mounting portion collectively forming a ratchet mechanism having an engaged configuration that prevents the mounting portion from pivoting about the mast member, the mounting portion including an actuator configured to be manipulated by a user to place the ratchet mechanism in a disengaged configuration that allows the jaw member to pivot about the mast member while the mounting portion remains around the mast member.

12. The carrier of claim 11, wherein the ratchet mechanism is configured to be placed in the disengaged configuration when the actuator is pressed by a user.

13. The carrier of claim 11, wherein the mast member provides a set of teeth and the actuator includes a pawl member that engages the teeth in the engaged configuration of the ratchet mechanism, and wherein manipulation of the actuator moves the pawl member out of contact with the teeth.

14. The carrier of claim 13, wherein the mounting portion includes a body, and wherein the actuator is pivotally connected to the body and spring-biased to urge the pawl member into engagement with the teeth.

15. The carrier of claim 13, wherein mast member includes a generally flat side that provides the set of teeth and also includes a cylindrical region, and wherein the flat side and the cylindrical region define parallel long axes.

16. The carrier of claim 15, where the mounting portion is pivotable in the disengaged configuration to a position that disposes the actuator adjacent the cylindrical region.

17. A carrier for a bicycle, comprising:
a tongue portion having a proximal end portion and a distal end portion, the proximal end portion being configured for connection to a vehicle hitch;
a base portion connected to the tongue portion and including a central region and a pair of end regions each pivotably connected to the central region and extending in opposite directions from the central region, each end region including a wheel support for a bicycle wheel and being pivotable between a horizontal use position and a vertical storage position; and
an arm assembly connected to the base portion and including a mast member and also including a jaw member mounted on the mast member and having a hook portion configured to engage a bicycle frame and/or a top portion of a bicycle wheel.

18. The carrier of claim 17, wherein each end region includes a bar member pivotably connected to the central region and a wheel support carried by the bar member.

19. The carrier of claim 18, wherein each wheel support is adjustably positionable along the bar member.

20. The carrier of claim 17, wherein each end region of the base portion is lockable in the horizontal use position and the vertical storage position.
